(19) United States
(12) Patent Application Publication
(10) Pub. No.: US 2007/0165499 A1
(43) Pub. Date: Jul. 19, 2007

(54) Motor transfer rate calibrated jumping

(75) Inventors: Ivon Franciscus Helwegen, Eindhoven (NL); Henricus Renatus Martinus Verberne, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,514

(22) PCT Filed: Apr. 28, 2005
(86) PCT No.: PCT/IB05/51392

§ 371 Date: Oct. 31, 2006

(30) Foreign Application Priority Data
May 4, 2004 (EP) 04101897.9

(51) Int. Cl. G11B 7/00

(52) U.S. Cl. 369/44.28; 369/30.1

(57) ABSTRACT

An optical disc drive scans tracks on a record carrier via a beam of radiation (24) from a head (22). The head is positioned on a selected track by a tracking system. A motor (40) moves the head transverse to the tracks in dependence on a position signal, which is generated in dependence on a number of revolutions of the motor A control unit (20) determines a distance of moving the head based on the position of the selected track and a current position of the head. An accurate track pitch ratio is retrieved from the record carrier to calculate the distance to be moved. A memory (34) stores a motor transfer rate as determined during a calibration process, which motor transfer rate indicates a number of revolutions of the motor for a predefined moving distance. The motor transfer rate enables translating the positions as determined and a distance to move the head into in revolutions of the motor.

The invention relates to a device for scanning a selected track in a pattern of substantially parallel tracks on a record carrier via a beam of radiation, the device comprising a head for providing the beam.

The invention further relates to a method of calibration.

The invention further relates to a computer program product for calibration.

The invention further relates to a record carrier having a pattern of substantially parallel tracks to be scanned via a beam of radiation.

U.S. Pat. No. 6,215,739 describes an optical storage device. The device has a head including a pickup unit on a carriage for generating a scanning spot on the track via a beam of light. Information; is represented by marks in the tracks. The optical storage device is equipped with a positioning system to position the head on a selected track of a record carrier by moving the carriage along a rail via a motor, such positioning usually called seeking. During a jump the motor is controlled via a driver based on a difference between a target position and an actual position determined by a microcomputer control unit. The actual distance of movement of the pickup unit during jumping is determined by counting a number of tracks that is crossed. The target position is calculated from a physical address of the data to be retrieved from the record carrier. The physical address indicates a distance in the longitudinal direction of the track. A distance in said longitudinal direction can be easily determined from the current physical address and the target physical address. However, the head is to be moved transverse to the tracks across the pattern of parallel tracks, i.e. in the radial direction of the disc shaped record carrier. For calculating from the longitudinal distance the number of tracks to be crossed, it is necessary to know the track pitch, i.e. the distance between the centers of neighboring tracks, because the track pitch may vary for different record carriers. The actual track pitch is measured by making a jump over a known distance and count the number of tracks crossed. Hence the document shows a way of calculating a number of tracks to be crossed when jumping from a first physical address to a second physical address. However, the prior art positioning system requires that the tracks crossed during jumping are accurately counted. For high density optical record carriers and high speed jumping such counting is difficult to achieve.

Therefore it is an object of the invention to provide a positioning system in a scanning device that provides accurate jumping without the need for accurate track counting.

According to a first aspect of the invention the object is achieved with a scanning device as defined in the opening paragraph, which device comprises control means for determining a position of the selected track, and for calculating a distance of moving the head based on the position of the selected track and a current position of the head, tracking means for positioning the head on the selected track, the tracking means comprising a motor for moving the head to the tracks in dependence on a position signal indicative of an actual position of the head, position means for generating the position signal in dependence on a number of revolutions of the motor, and means for storing a motor transfer rate as determined during a calibration process, which motor transfer rate is indicative of a number of revolutions of the motor for a predefined distance of moving the head.

According to a second aspect of the invention the object is achieved with a method of calibration as defined in the opening paragraph, which method is for determining a motor transfer rate, and storing the motor transfer rate in the above mentioned scanning device, the method comprising the steps of positioning the head on a first predetermined position based on a first special mark on the record carrier, and subsequently, while counting the number of revolutions of the motor, positioning the head on a second predetermined position based on a second special mark on the record carrier, determining, from the record carrier, a jump distance in a direction of movement of the head between the first special mark and the second special mark, and calculating the motor transfer rate based on the jump distance and said counted number of revolutions of the motor.

According to a third aspect of the invention the object is achieved with a record carrier as defined in the opening paragraph, which record carrier comprises control parameters in a predefined location in the tracks, the control parameters including a track pitch ratio parameter indicative of a number of tracks in the pattern for a predetermined distance transverse to the tracks.

The effect of the measures is that positions of the head and the selected track are determined in physical distances transverse to the track direction. During jumping to the selected track the distance of movement is derived from the number of revolutions of the motor in a highly accurate way due to the motor transfer rate being calibrated. Track counting is not required for detecting the distance moved. It is to be noted that the motor transfer rate, the starting position of the head and the position of the selected track are determined accurately as follows. The motor transfer rate is determined by said process of calibration and then storing the motor transfer rate in the device. The motor transfer rate indicates the transfer function of motor revolutions to physical distance, e.g. a number of revolutions of the motor for a predefined distance of moving the head, or a distance corresponding to a predefined number of revolutions, etc. The current starting position of the head is based on reading information from the track before the jump, and the target position is based on a target physical address of the selected track. This has the advantage that jumping is performed at high speed on a high density record carrier, i.e. without track counting, and without the need for an additional position sensor for controlling the position of the head.

The invention is also based on the following recognition. Commonly the seeking of selected tracks in optical drives is based on counting tracks during jumping. The inventors have seen that by mechanically calibrating the transfer function of the head movement motor, and accurately knowing the track pitch of the record carrier, a sufficiently accurate jump can be made. A fast, long motor transfer rate calibrated jump may be followed by a slow, short distance track counting jump to arrive exactly at the selected track. The total access time will still be advantageously low. Moreover, the track pitch may be detected from the record carrier, e.g. by making a long jump after inserting the record carrier. However, by reading the track pitch ratio parameter from the record carrier from the predefined location, there is no need for detecting the actual track pitch after inserting the record carrier in the drive. Hence the startup process after inserting the disc will be faster.

In an embodiment of the device the control means are arranged for determining the position of the selected track in dependence of a physical address indicating a linear position along the track, and in dependence of an actual track pitch ratio indicative of the number of tracks in the pattern for a predetermined distance transverse to the tracks. This has the advantage that from the physical addresses and a known length of data blocks corresponding to the addresses, and the track pitch, the radial position of the current track and target track can be easily calculated.

In an embodiment of the device the control means are arranged for retrieving the actual track pitch ratio from an actual track pitch ratio parameter from the record carrier. It is noted that the track pitch ratio parameter needs to indicate a track pitch ratio with sufficient resolution and accuracy to allow accurate jumping, e.g. indicating the actual physical track pitch or a number of tracks per mm with 1% or better accuracy. Only indicating a standardized track pitch of a disc type by a general standard parameter does not reflect the actual track pitch ratio with sufficient accuracy. It is noted that the track pitch ratio may be measured after entering the record carrier into the device, in a track pitch ratio calibration procedure. However, such calibration will take time, which is annoying to the user who just inserted the record carrier for his application. On the contrary, when the track pitch ratio parameter is read from the record carrier, this has the advantage that the user may substantially immediately access the record carrier and power consumption is decreased (especially of importance for mobile applications).

In an embodiment of the device the control means are arranged for performing the calibration process for determining and storing the motor transfer rate. The motor transfer rate may be calibrated only once during manufacture or during a maintenance program. However, it is preferred that the device itself is able to perform calibration. This has the advantage that effects of wear or aging are taken into account.

In an embodiment of the device the calibration process comprises positioning the head on a first predetermined position based on a first special mark on the record carrier, and subsequently, while counting the number of revolutions of the motor, positioning the head on a second predetermined position based on a second special mark on the record carrier, determining, from the record carrier, a jump distance in a direction of movement of the head between the first special mark and the second special mark, and calculating the motor transfer rate based on the jump distance and said counted number of revolutions of the motor. Due to the special marks on the record carrier, for example a special maintenance record carrier or a record carrier having such special marks according to a predefined standard, an accurate calibration is facilitated.

In an embodiment the record carrier comprises a first special mark on a predefined first radial position, and a second special mark on a predefined second radial position, the first and second position bordering the pattern of substantially parallel tracks. The special marks, e.g. predefined data patterns or annular areas having a deviating reflection, are at the borders of the pattern of substantially parallel tracks, which constitutes the area of the record carrier effectively used for data. This has the advantage that the jump distance between both special marks is maximized, and hence the calibration is less sensitive to small errors, and more accurate.

Further preferred embodiments of the device according to the invention are given in the claims.

These and other aspects of the invention will be apparent from and elucidated further with reference to the embodiments described by way of example in the following description and with reference to the accompanying drawings, in which

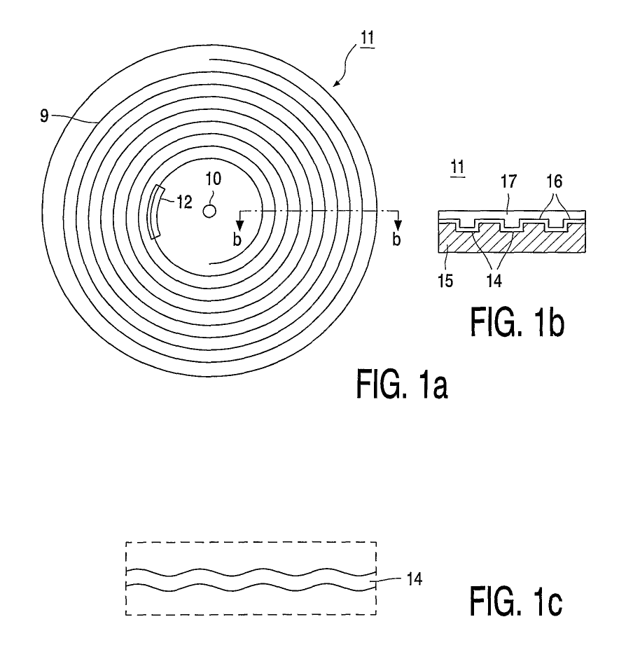

FIG. 1a shows a disc-shaped record carrier,

FIG. 1b shows a cross-section taken of the record carrier,

FIG. 1c shows an example of a wobble of the track,

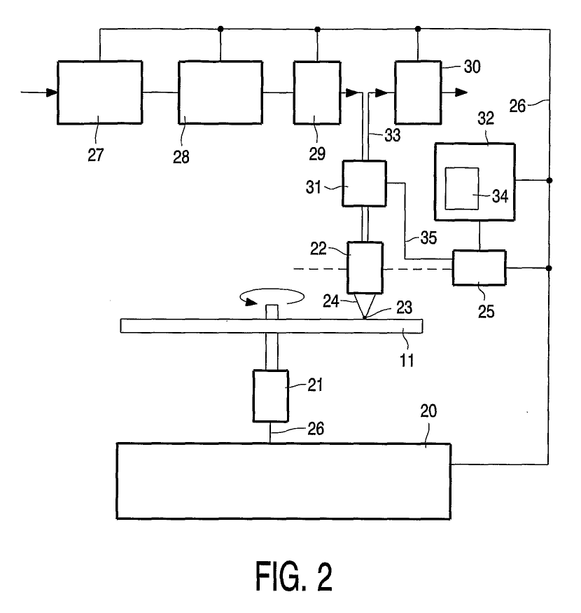

FIG. 2 shows a scanning device having motor transfer rate calibrated jumping,

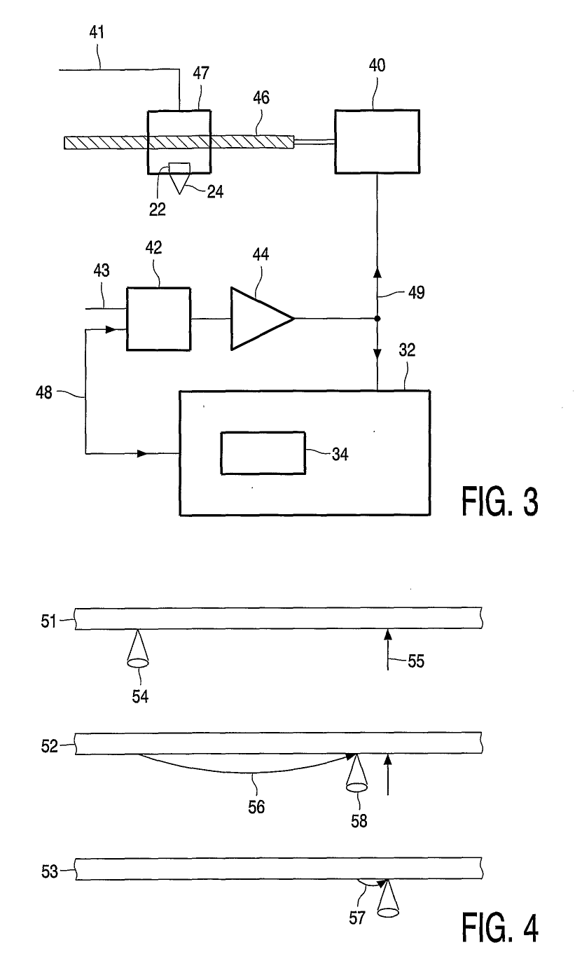

FIG. 3 shows a tracking servo system,

FIG. 4 shows a motor transfer rate calibrated jump,

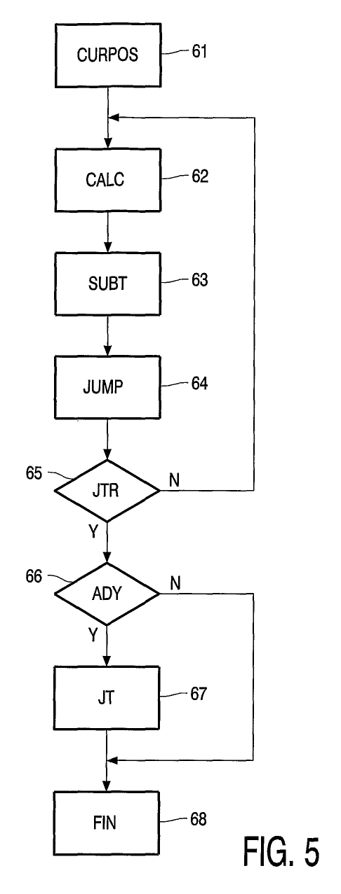

FIG. 5 shows a flow diagram of an access process,

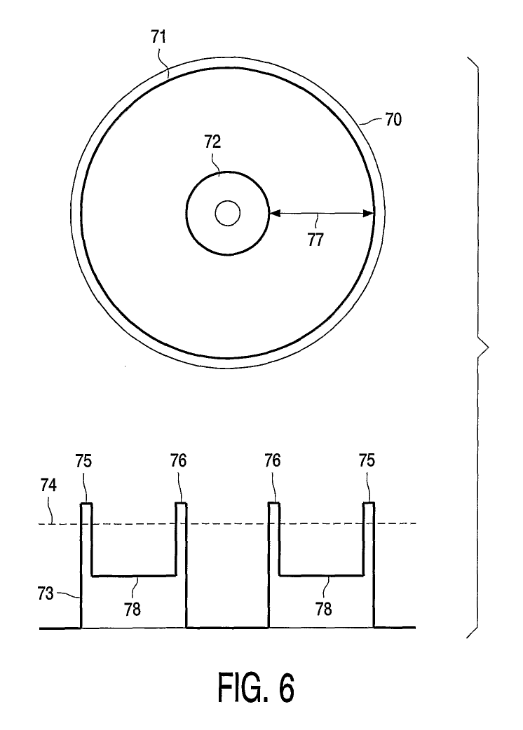

FIG. 6 shows a record carrier having boundary strips and a reflected signal level, and

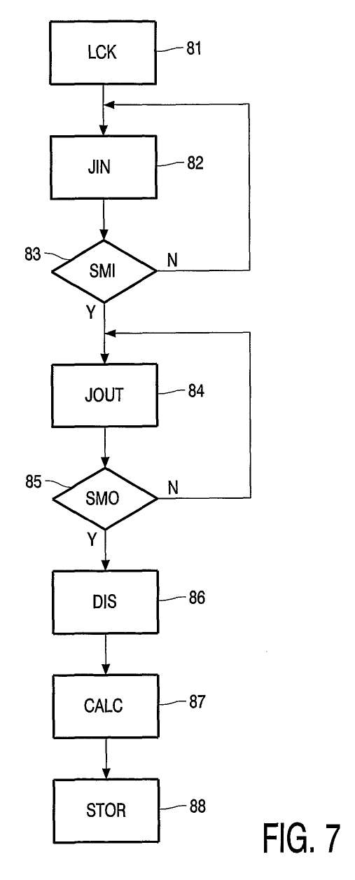

FIG. 7 shows a flow chart of a calibration procedure.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, the DVD+RW, and the Blu-ray Disc (BD). The track 9 on the recordable type of record carrier is indicated by a pre-embossed track structure provided during manufacture of the blank record carrier, for example a pregroove. Recorded information is represented on the information layer by optically detectable marks recorded along the track. The marks are constituted by variations of a physical parameter and thereby have different optical properties than their surroundings, e.g. variations in reflection. Control parameters as defined in a recording format may be recorded in a predefined area 12.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. The record carrier may be intended to carry real-time information, for example video or audio information, or other information, such as computer data.

FIG. 1c shows an example of a wobble of the track. The Figure shows a periodic variation of the lateral position of the track, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the prior art wobble as shown in FIG. 1c in a writable CD system comprising disc control information encoded in such a manner can be found in U.S. Pat. No. 4,901,300 (PHN 12.398) and U.S. Pat. No. 5,187,699 (PHQ 88.002).

According to the invention the record carrier has a track pitch ratio indicator 12 at a predefined location on the recording layer. Motor transfer rate calibrated jumping, which requires an accurate track pitch ratio, is explained below in detail. The track pitch ratio indicator may specify the actual track pitch ratio, i.e. the number of tracks for a predetermined distance transverse to the tracks, e.g. the number of tracks per mm. Alternatively the track pitch ratio may indicate the track pitch itself with sufficient accuracy. For accuracy the track pitch ratio indicator requires at least a 7 or 8 bit track pitch ratio parameter value for a better than 1% accuracy. Hence the track density is written in the disc, which can be done very easily during mastering of the master disc. In this way discs with different track pitches are distinguishable.

The predefined position containing the track pitch ratio indicator is indicated schematically as a part of the track 9 by the rectangle 12 in the Figure, but in practice the track pitch ratio indicator may be implemented as a limited amount of digital control data, e.g. included in a lead-in area of the record carrier. In a particular embodiment the pregroove comprises a modulation, such as the wobble described above with FIG. 1c, for transferring control data relating to the recording parameters of the record carrier to a recording device, which control data includes the track pitch ratio indicator. In an embodiment the track pitch ratio parameter may be stored repetitively along the tracks to obviate searching a single predefined position far away from an initial position of the head.

FIG. 2 shows a scanning device having motor transfer rate calibrated jumping. The device is provided with means for scanning a track on a record carrier 11, which means include a drive unit 21 for rotating the record carrier 11, a head 22, a tracking servo unit 25 for positioning the head 22 on the track and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head may contain all optical elements, the laser and detectors as an integrated unit, usually called Optical Pickup Unit (OPU), or may contain as a movable unit only some of the optical elements, while the remaining optical elements and laser and detector are located in a unit on a fixed mechanical location, usually called split-optics, the beam being transferred between both units, e.g. via a mirror. The head further comprises (not shown) a focusing actuator for focusing the beam to the radiation spot on the track by moving the focus of the radiation beam 24 along the optical axis of said beam, and a tracking actuator for fine positioning of the spot 23 in a radial direction on the center of the track. The tracking actuator may comprise coils for radially moving an optical element or may alternatively be arranged for changing the angle of a reflecting element. For reading the radiation reflected by the information layer is detected by a detector of a usual type, e.g. a four-quadrant diode, in the head 22 for generating detector signals coupled to a front-end unit 31 for generating various scanning signals, including a main scanning signal 33 and error signals 35 for tracking and focusing. The error signals 35 are coupled to the tracking servo unit 25 for controlling said positioning of the head and the tracking actuators. The main scanning signal 33 is processed by read processing unit 30 of a usual type including a demodulator, deformatter and output unit to retrieve the information.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device may be provided with recording means for recording information on a record carrier of a writable or re-writable type. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the power of the beam of radiation is controlled by modulator 29 to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

In an embodiment the device has a pregroove demodulation unit for detecting pregroove modulation in the scanning signal. The scanning signal is processed in the front-end unit 31 to derive a component representing the pregroove modulation. Recording control information including the track pitch ratio indicator is retrieved from the pregroove modulation by the pregroove demodulation unit as discussed above with reference to FIG. 1c.

The improvements described below relate to an optical disc drive sledge mechanism. In order to be able to read/write selected tracks on a complete disc the head is mounted on a movable sledge. The sledge is movable from an inner to an outer radius of the optical disc. Data to be accessed subsequently may be scattered all over the disc requiring jumping of the laser spot from one (defined) place on the disc to another (also defined place). Hence the jumps are needed to access the complete disc; the process usually called seeking featuring the sledge for radially positioning the head. Ifjumping is performed relatively slow, a track count mechanism is able to count track-crossings obtained from the optical spot detector arrangement. The track count is compared with the pre-calculated value, and data read back is started once the target count is reached, as discussed with the prior art document U.S. Pat. No. 6,215,739. However for high density record carriers, and while jumping at high speed, track counting is unreliable or even impossible. Since there is a need to reduce access times, in the current invention high speed jumping is done based on distance of movement without the track count mechanism. To enable such distance based jumping there is a need to calculate the distance between the position of the head and a selected track, and thereto the current position of the head and the target position of the selected track are determined. Moreover it is necessary to take into account a sledge position transfer function (e.g. distance per second per volt of motor drive signal) called motor transfer rate. The control unit 20 is arranged for determining the position of the selected track, and for calculating a distance of moving the head based on the position of the selected track and a current position of the head. The positions may be derived from the physical addresses of data blocks in the track as explained below.

For enabling the distance based jumping there is a need to know the movement of the sledge. Although it might be possible to include position sensors to actually detect the radial position of the head or sledge, such sensors would require space, while accurate sensors add significant cost to a disc drive. Hence the device is provided with a position unit 32 that generates a position signal indicative of an actual position of the head in dependence on a number of revolutions of the motor. The motor transfer rate is indicative of a ratio of a number of the revolutions and a head move distance. The device has a memory 34 for storing the motor transfer rate as determined during a calibration process. The memory 34 may, for example, be located in the position unit 32 or in the control unit 20. The position signal is coupled to the tracking servo unit 25 for positioning the head on the selected track: The tracking servo system includes the motor for moving the head along a rail transverse to the tracks in dependence on the position signal. Hence the position of the head is based on the amount of revolutions of the motor that moves it, and a calibrated motor transfer rate which indicates the amount of distance of'movement of the head for a number of the revolutions.

FIG. 3 shows a tracking servo system, which corresponds to the tracking servo unit 25 in FIG. 2, and is arranged for positioning the head on the track. The head 22 generates a scanning signal 41, and is mounted on a surrounding support unit, usually called sledge or carriage 47, which is mechanically coupled to a rail 46. A motor 40 is coupled to the carriage 47 for moving the head 22 along the rail transverse to the tracks. In practical embodiments the rail 46 may include supporting rail on which the carriage is positioned by wheels, a longitudinal worm axis, etc, all well known in the art of mechanical construction of optical disc drives.

The tracking servo system includes, for constituting a main servo loop, the motor 40, the position unit 32 for generating a position signal 48 in dependence of an actual position of the head based on the number of revolutions of the motor, and an amplifying unit 44. The amplifying unit 44 generates a driving signal 49 coupled to the motor 40 based on an error signal from error unit 42 that receives as input a selected target position signal 43 and the position signal 48. A memory 34 stores a motor transfer rate as determined during a calibration process. The memory 34 is coupled to the position unit 32. The position signal 48 may be equivalent to a number of revolutions, or to a radial distance (a position in mm), which translation can be performed using the motor transfer rate. Similarly the target position signal is to be expressed in revolutions or in mm.

It is noted that the position unit 32 may be arranged to read information from the tracks of the record carrier for detecting the actual position of the head. Additionally, during slow transverse movement of the head, a track crossing signal may be generated, and the tracks crossed may be counted. Such slow jumps may be applied to jump short distances.

In an embodiment the position unit 32 is arranged for determining the amount of revolutions of the motor based on the driving signal 49 coupled to the motor. For example the motor may be arranged as a stepping motor. The number of pulses applied to the stepping motor may be counted. Alternatively the motor may be a (3-phase) synchronous motor, driven by sinusoidal drive signals having a known period related to the amount of revolutions of the motor. The motor transfer rate parameter indicates the actual relation between the movement of the head in mm and the controlled periodic drive signals to the motor. It is noted that for such relation to be reliable it is required that the motor (e.g. of the synchronous or stepping type) is able to rotate according to the drive signals without slipping.

The control unit calculates the jump distances according to the following. The non-volatile calibration memory 34 stores the motor transfer rate, e.g. the number of revolutions/mm of the sledge motor. The number of tracks per mm is called the track pitch ratio is retrieved from the record carrier as discussed above. Equation (1) shows how to calculate the number of revolutions per track (# revs/track) from the motor transfer rate (#revs/mm) and track pitch ratio (#tracks/mm) values.

$$( \# revs / track ) = \frac{( \# revs / mm )}{( \# tracks / mm )} \qquad ( 1 )$$

When a seek needs to be made, the user normally gives an address to seek to. A formula that is based on the surface area of the disc is used to calculate the number of millimeters to jump. For a disc having physical addresses indicating ECC blocks of a predefined length, the formula looks like equation (2) and (3). The sample values are given for a proposed standard called a portable blu-ray disc.

$$ECC = \frac{π \cdot ( {R}_{o}^{2} - {R}_{i}^{2} )}{q \cdot {L}_{ECC}} \qquad ( 2 )$$

$${R}_{o} = \sqrt{\frac{ECC \cdot q \cdot {L}_{ECC}}{π} + {R}_{i}^{2}} \qquad ( 3 )$$

where
ECC=the ECC block number=physical address,
R₀=the radius where the ECC block number is located,
Rᵢ=the inner radius of the record carrier, e.g. 0.006 m,
q =the track pitch=1/(#tracks/m), e.g. 3.20·10⁻⁷ m,
L_{ECC}=the ECC block length, e.g. 7.67·10⁻² m

The current position is known, so the number of tracks to jump can be calculated like is done in equation (4).

$$T = \frac{{R}_{o}^{new} - {R}_{o}^{cur}}{q} \qquad ( 4 )$$

where
T =the number of tracks to jump (minus sign=jump to inner side, plus sign=jump to outer side),
R₀^{cur}=the current radius where the OPU is located,
R₀^{new}=the desired radius to locate the OPU.

The total number of revolutions of the motor is calculated by multiplying the number of tracks T with the number of revolution per track from formula (1), and the compared to the actual number of revolutions during movement. This corresponds to calculating the distance to move the head in mm using the actual track pitch ratio and the physical addresses of current and target track and subsequently translating the distance into a number of revolutions using the motor transfer rate.

FIG. 4 shows a motor transfer rate calibrated jump. In a first state 51 a record carrier is schematically indicated having a head 54 in a current position. A target position 55 is indicated by an arrow. In a second state 52 the record carrier is shown having the head moved to a position just before the target position 55, the movement of the head based on motor transfer rate being indicated by an arrow 56. In an embodiment as shown the distance has been calculated and a small amount has been deducted to prevent the head from landing too far. At the first landing position 58 the track is read for detecting a physical address, i.e. to determine the remaining distance to jump (if any). In a third state the record carrier is shown having the head moved to a position at the target position 55, the final small jump of the head based on track counting being indicated by an arrow 57.

FIG. 5 shows a flow diagram of an access process. In a first step 61 CURPOS the current position of the OPU is checked by performing a wobble lock and reading the wobble address. In a step 62 CALC the number of tracks to jump, and subsequently the number of revolutions that the sledge motor needs to make, is calculated. In a step SUBT 63 a margin is subtracted to be sure that the OPU arrives before the right position. In a step JUMP 64 a jump is performed and the physical address of the new position is read. In a step JTR 65 it is judged, by comparing the remaining distance to a preset threshold, if the additional small jump may be made by the actuator based on track counting. If still a large distance remains, a further motor transfer rate calibrated jump is made by going back to step CALC 62. Otherwise, in step ADJ 66, it is decided if an additional jump needed at all, or if the head is at the right track. If not, in step JT 67 a slow actuator jump of some tracks is performed based on counting the tracks. In step FIN 68 the jump is finished when the head is at the selected target track.

Note that FIG. 5 assumes that a disc with a wobble encoded position signal is inserted. If the type of disc that is inserted doesn't have a wobble signal, the physical address information needs to be abstracted from the HF-signal. In addition it is noted that the sledge may never move when no disc is inserted, because no feedback about the actual position can be given. Hence before executing a jump, the presence of a disc has to be verified.

It is noted that the calibration process of the motor transfer rate may be performed during manufacture of the device, and the results stored at final stage of assembly of the device. However it is preferred to regularly perform the calibration process to account for changes in the motor transfer rate, for example during a maintenance process.

In an embodiment the position means 32 are arranged for performing the calibration process. Hence the function of performing the calibration process is included in the device itself as explained below.

FIG. 6 shows a record carrier having boundary strips and a reflected signal level. A record carrier 70 has an outer boundary strip 71 and an inner boundary strip 72. The boundary strips enclose a data zone 77 on the record carrier, i.e. are bordering the pattern of substantially parallel tracks for containing data. The boundary strips have an optically detectable property that has a value that is substantially different from the value in the data zone 77. For example the boundary strips are highly reflective, whereas the average reflection in the data zone is significantly lower. In a lower part of FIG. 6 a scanning signal 73 is shown for a head moving in a direction transverse to the tracks. When the head is positioned on the boundary strips, a high signal level well above a threshold level 74 is found. The outer boundary strip 71 results in a special signal level 75, and inner boundary strip 72 in signal level 76, whereas the data zone has a normal signal level 78. In the example the strips are highly reflective, and the special signal level is higher than the normal level. However, the special signal level may also be lower, or a different optical property may be used such as a substantially different wobble frequency of the tracks in the boundary strips. The boundary strips are located on a predefined distance, or the distance may be included in control data on the record carrier. For calibration the head is moved between the inner and outer strips until the special signal level is detected.

Note that the disc with the highly reflective areas can be easily used for calibration during use in the field. When the spot enters the highly reflective area, the level of the low-pass filtered HF-signal increases. Simple threshold detection can detect if the OPU enters the inner or outer boundary strip of the disc.

FIG. 7 shows a flow chart of a calibration procedure. In a first step LCK 81 a wobble lock is performed and the number of tracks/mm is retrieved from the wobble. The control data on the record carrier may include the track pitch ratio, e.g. the number of tracks per mm, as explained above. Step 81 assumes the control data to encoded in the wobble, but the control data may also be pre-recorded differently, e.g. on a predefined location, or in a special control data file. In step JIN 82 a small jump is made towards the inner side of the disc. In step SMI 83 it is tested if the special mark on the inner side of the data zone is reached, e.g. the highly reflective inner boundary strip 72. In a step JOUT 84 the sledge is jumping slowly towards the outer side of the disc, while counting the number of tracks and the number of revolutions of the motor. In a step SMO 85 it is tested if the special mark on the outer side of the data zone is reached, e.g. the highly reflective outer boundary strip 71. The special marks may also be special patterns in the wobble as shown in FIG. 1c, etc. In step DIS 86 determines, from the record carrier, a distance in a direction of movement of the head between the first special mark and the second special mark. Subsequently in step CALC 87 the number of revolutions/mm, i.e. the motor transfer rate, is calculated, which is stored in step STOR 88. Equation (5) shows how to calculate the number of revolutions/mm from the measurements.

$$( \# revs / mm ) = \frac{( \# revs\_counted ) * ( \# tracks / mm )}{( \# tracks\_counted )} \qquad ( 5 )$$

The step DIS 86 may determine the distance between the special marks or boundary strips by reading a distance parameter from the record carrier indicative of a distance between the first and second special mark, calculating a distance between the first and second special mark by reading a track pitch ratio parameter from the record carrier and calculating the positions of the first and second special mark in dependence of respective physical addresses indicating a linear position along the track, or establishing a predefined jump distance between the first and second special mark from detecting a type of the record carrier.

It is noted that the calibration process may be performed in the position means 32, in a central processor of the optical disc drive, or via a remote processing unit, e.g. under control of a host computer implemented in a software product such as a driver. The record carrier having the special marks as shown in FIG. 6 may contain the software for performing the calibration process, e.g. as a special maintenance calibration disc, or as part of a standard optical disc format. Calibration may be first time done in the factory, or when the drive detects its first power on, or detects the special maintenance disc.

In an embodiment the device detects the need for a calibration. Subsequently the disc drive may recalibrate the motor transfer rate. The need for starting the calibration process may be detected in various ways. For example a timekeeping mechanism is implemented to detect if a predetermined period of time has lapsed since a previous calibration process, e.g. a clock/calendar unit and memory storing a date of the last effective calibration. Alternatively, or in combination, it may be determined if a predetermined amount of operational use has lapsed since a previous calibration process, e.g. a number of power-on hours or a number of seeks.

The need for a new calibration process may also be based on detecting positioning errors during normal use, i.e. start if an amount of positioning errors after a head movement is detected, or if an amount of deviation in the positioning errors is exceeded. When the mismatch between the landing position 58 (in FIG. 4) after the motor transfer rate calibrated jump and the desired spot position 55 becomes too big, or a substantial deviation occurs too often, the system detects a need for a recalibration. The actual occurrence of positioning errors during use is a clear indication that the motor transfer rate does not correspond any longer to the actual transfer rate. Both overshoot and undershoot in the position are a sign of an incorrect stored motor transfer rate.

Further conditions may be tested before actually starting the calibration process. In particular it may be determined if the operational circumstances allow the calibration to be performed. This may for example be derived from the recent history of accessing the record carrier by the user, or by actively asking permission to the user to perform calibration. Further conditions may include detecting if the device is coupled to a mains power source. Calibration requires additional power, which preferably is not consumed from a battery.

The improvements are particularly relevant for so called small form factor devices, because there is no need for a position sensor, while high speed jumping without track counting is achieved. In general, in battery powered, portable devices, the amount of power dissipated for seeking in the tracking servo system may be reduced. The reduction is achieved by omitting the need for calibration of the jump distances for a record carrier just inserted, and by accurately jumping and thereby reducing the number of subsequent jumps needed to arrive at the selected track.

Although the invention has been mainly explained by embodiments using disc shaped optical record carriers, the invention is also suitable for other record carriers such as rectangular optical cards, annular track patterns, magnetic discs or any other type of information storage system that needs positioning a head. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for scanning a selected track in a pattern of substantially parallel tracks on a record carrier (11) via a beam of radiation (24), the device comprising
a head (22) for providing the beam,
control means (20) for determining a position of the selected track, and for calculating a distance of moving the head based on the position of the selected track and a current position of the head,
tracking means (25) for positioning the head on the selected track, the tracking means comprising a motor (40) for moving the head transverse to the tracks in dependence on a position signal indicative of an actual position of the head,
position means (32) for generating the position signal in dependence on a number of revolutions of the motor, and
means (34) for storing a motor transfer rate as determined during a calibration process, which motor transfer rate is indicative of a number of revolutions of the motor for a predefined distance of moving the head.

2. Device as claimed in claim 1, wherein the control means (20) are arranged for determining the position of the selected track in dependence of a physical address indicating a linear position along the track, and in dependence of an actual track pitch ratio indicative of the number of tracks in the pattern for a predetermined distance transverse to the tracks.

3. Device as claimed in claim 2, wherein the control means (20) are arranged for retrieving the actual track pitch ratio from an actual track pitch ratio parameter from the record carrier (11).

4. Device as claimed in claim 1, wherein the position means (32) are arranged for determining the amount of revolutions of the motor in dependence of a drive signal coupled to the motor.

5. Device as claimed in claim 1, wherein the control means (20) are arranged for performing the calibration process for determining and storing the motor transfer rate.

6. Device as claimed in claim 5, wherein the calibration process comprises
positioning (82,83) the head on a first predetermined position based on a first special mark on the record carrier, and subsequently, while counting the number of revolutions of the motor,
positioning (84,85) the head on a second predetermined position based on a second special mark on the record carrier,
determining (86), from the record carrier, a jump distance in a direction of movement of the head between the first special mark and the second special mark, and
calculating (87) the motor transfer rate based on the jump distance and said counted number of revolutions of the motor.

7. Device as claimed in claim 6, wherein determining (86) said jump distance comprises at least one of:
reading a distance parameter from the record carrier indicative of a distance between the first and second special mark;
calculating a distance between the first and second special mark by reading a track pitch ratio parameter from the record carrier and calculating the positions of the first and second special mark in dependence of respective physical addresses of the special marks;
establishing a predefined jump distance between the first and second special mark from detecting a type of the record carrier.

8. Device as claimed in claim 6, wherein the positioning of the head on a on a special mark (71,72) comprises detecting an amount of reflected radiation deviating at least a predetermined amount from an amount of reflected radiation from the pattern of substantially parallel tracks.

9. Device as claimed in claim 5, wherein the control means (20) are arranged for performing the calibration process based on at least one of the following conditions:
if a predetermined period of time has lapsed since a previous calibration process;
if a predetermined amount of operational use has lapsed since a previous calibration process;
if the device is coupled to a mains power source;
if an amount of positioning errors after a head movement is detected;
if an amount of deviation in the positioning errors is exceeded.

10. Method of calibration for determining a motor transfer rate to be stored in a device for scanning a selected track in a pattern of substantially parallel tracks on a record carrier (11) via a beam of radiation (24), the device comprising
a head (22) for providing the beam,
control means (20) for determining a position of the selected track, and for calculating a distance of moving the head based on the position of the selected track and a current position of the head,
tracking means (25) for positioning the head on the selected track, the tracking means comprising a motor (40) for moving the head transverse to the tracks in dependence on a position signal indicative of an actual position of the head,
position means (32) for generating the position signal in dependence on an amount of revolutions of the motor, and
means (34) for storing the motor transfer rate, which motor transfer rate is indicative of a number of revolutions of the motor for a predefined distance of moving the head, the method comprising the steps of
positioning the head on a first predetermined position based on a first special mark on the record carrier, and subsequently, while counting the number of revolutions of the motor,
positioning the head on a second predetermined position based on a second special mark on the record carrier,
determining, from the record carrier, a jump distance in a direction of movement of the head between the first special mark and the second special mark, and
calculating the motor transfer rate based on the jump distance and said counted number of revolutions of the motor.

11. Computer program product for calibration for determining a motor transfer rate of a device for scanning a record carrier, which program is operative to cause a processor to perform the method as claimed in claim 10.

12. Record carrier having a pattern of substantially parallel tracks to be scanned via a beam of radiation, which record carrier comprises control parameters in a predefined location in the tracks, the control parameters including a track pitch ratio parameter (12) indicative of a number of tracks in the pattern for a predetermined distance transverse to the tracks.

13. Record carrier as claimed in claim 12, wherein the record carrier comprises a first special mark (71) on a predefined first radial position, and a second special mark (72) on a predefined second radial position, the first and second position bordering the pattern of substantially parallel tracks.
